(19) United States
(12) Patent Application Publication
(10) Pub. No.: US 2004/0180791 A1
(43) Pub. Date: Sep. 16, 2004

(54) Lure with sonar transmissions means

(76) Inventors: Richard B. Cass, Ringoes, NJ (US); John McBride, Allentown, NJ (US)

Correspondence Address: SYNNESTVEDT & LECHNER, LLP, 2600 ARAMARK TOWER, 1101 MARKET STREET, PHILADELPHIA, PA, 191072950

(21) Appl. No.: 10/480,029

(22) PCT Filed: Jun. 10, 2002
(86) PCT No.: PCT/US02/18117

Related U.S. Application Data
(60) Provisional application No. 60/297,121, filed on Jun. 8, 2001.

(51) Int. Cl. H01B 1/00

(52) U.S. Cl. 505/100

(57) ABSTRACT

A lure for attracting sea life, the lure comprising: a housing; an energy-harvesting transducer contained within the housing and operatively connectable to an external deformation source for deforming the energy-harvesting transducer, the energy-harvesting transducer being configured to generate an electrical signal in response to being deformed; transducer-driving circuitry contained within the housing and electrically connected to the energy-harvesting device, the transducer-driving circuitry configured to receive the electrical signal and to output a driving signal suitable for powering at least one transmitting transducer; and at least one transmitting transducer electrically connected to the transducer driving circuitry, the transmitting transducer deforming in response to the driving signal to generate a sonar signal.

The present invention uses PFCs to harvest energy by placing piezoelectric materials in a location where they will be compressed, bent, torqued, or otherwise deformed. This energy is then used to power one or more output PFCs which broadcast the sonar. The flexible nature of the output PFCs allows them to conform to the surface of the lure which tan be made to look like a fish rather than a substrate for a rigid transducer. Furthermore, as is disclosed in the U.S. patent application Ser. No. 09/834,305, herein incorporate by reference, a single PFC can be made with different size fibers to produce different frequencies. Therefore, a single PFC, contour molded to the lure, can transmit a variety of sonar frequencies. The result is a self-contained, self-power lure that not only transmits various sonar frequencies, but also looks like a fish.

### BRIEF DESCRIPTION OF DRAWINGS

FIG. 1 shows a preferred embodiment of the fishing lure of the present invention.

### DETAILED DESCRIPTION OF PREFERRED EMBODIMENT

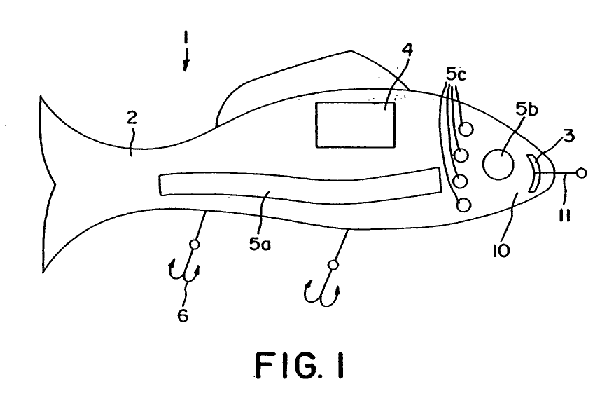

Referring to FIG. 1, a preferred embodiment of the fish lure 1 of the present invention is shown. Although the present invention is described herein in terms of a fishing lure, it should be understood that the present invention is not restricted to such an embodiment and may be configured, for example, as a lobster or other sea life organism which has a tendency to lure other sea life organisms.

Generally, the fish lure 1 comprises a housing 2, which in this embodiment is configured to resemble a fish but may be configured to resemble any desired lure as mentioned above. Within the housing is an energy-harvesting transducer 3, which is operatively connectable to an external deformation source for deforming the energy-harvesting transducer. The energy-harvesting transducer is configured to generate an electrical signal in response to being deformed. Also contained within the housing is transducer-driving circuitry 4, which is electrically connected to the energy-harvesting device. The transducer-driving circuitry is configured to receive energy generated by the energy-harvesting transducer and to output a driving signal suitable for powering a transmitting transducer 5. At or near the surface of the housing is mounted at least one transmitting transducer 5 which is electrically connected to the transducer-driving circuitry. The transmitting transducer 5 generates a sonar signal in response to the driving signal. These elements of the active fish lure are described in greater detail below.

The housing serves a number of purposes in the preferred embodiment. First, it provides a watertight housing for the various electronics housed therein. As such, its seams preferably are gasketed or otherwise sealed to prevent water entry. Such techniques for making a housing watertight are well known and, accordingly, are not discussed in detail herein. Rather than making the housing watertight, it may be preferable to package the electronics contained in the housing in watertight enclosures. Again, such techniques are well known and are not addressed in detail herein. The housing also needs to be visually appealing for the desired sea life. This typically requires forming the housing to resemble food of the desired sea life. Such food may be fish, shell fish, plant life, and bugs (including insects, arachnid, and the like). Shaping a housing to reassemble such food is well within the purview of one skilled in the art and will not be addressed in detail herein. The housing may also act as a purchase point for hooks 6 or other devices for ensnaring or otherwise interacting with, the lured sea organisms.

The housing contains the energy-harvesting transducer which generates the energy for powering the sonar transmitting elements. Preferably, the energy-harvesting comprises a piezo-electric fiber composite (PFC): Such PFCs are described for example, in pending U.S. application Ser. No. 09/834,305, incorporated herein by reference, and are commercially available from Advanced Cerametrics ( Lambertville, N.J.).

Various fiber materials may be used in the PFC. Suitable materials include, for example, all members of the PZT (lead zirconium titanate) family, lead niobate (PbNbO₆), lead titanate (PbTiO₃), barinum titanate (BaTiO₃), electrostrictive materials, e.g. magnesium niobate (MgNbO₆), sodium bis moth titanate (pure or co-doped), other lead-based ceramics doped with lanthanum; tin, or niobium, and shape-memory piezoelectric materials (e.g., Pb₃ MgNb₂O₆), and relaxor materials (ferroelectric/non ferroelectric). Preferably, the piezoelectric material is PZT. Suitable fibers made of piezoelectric material, such as PZT, are commercially available from Advanced Cerametrics, Lambertville, N.J. Techniques for preparing piezoelectric fiber are known in the art, although preparing the fibers according to the spinning techniques described in U.S. Pat. No. 5,827,797 is preferred.

During operation, the energy-harvesting transducer is operatively connected to an external deformation source which deforms it. Preferably, the external deformation source is associated with wave action or some other force that causes the energy-harvesting transducer to deform periodically. Such an external deformation source might be, for example, a fishing line which is periodically tugged by the pole to which the line is attached. As is well known, this tugging action may result from the user moving the pole or from wave action moving the user if he is on a floating device (e.g., a boat). Alternatively, the line may be attached to a buoy or float which tugs on the line through ordinary wave action. Such an embodiment may be preferable if the lure device is used for traps, such as crab or lobster traps. Either way, the result is the same, the line tugs on the energy-harvesting transducer causing it to deform and generate an electrical signal. For example, tests on larger PFC's (250 mm diameter, 0.25 mm thickness) have produced up to 250 volts per stroke. Thus, a 60 mm diameter PFC, which is a preferred size for the lure described herein, can be expected to produce 50 to 80 volts several times a second. By harvesting energy from an external deformation source, the lure of the present invention can be self-powered thereby reducing the need for expensive, bulky and heavy internally-contained energy sources.

Preferably, the energy-harvesting transducer is configured such that it can be operatively connected to the external deformation source. For example, the energy-harvesting transducer may be molded into the housing and provide an attachment point for the external deformation source (e.g., a line) to be secured directly to it. As used herein, however, the term “operatively” is used to indicate that the energy-harvesting transducer need not be directly connected to the external deformation source but may be coupled thereto through other components. For example, in the preferred embodiment of FIG. 1, the energy-harvesting transducer is disposed in the nose 10 of the lure. A connector 11, in the form of a guide hook in this embodiment, attaches to or through the transducer and is readily connectable to a fishing line such that the vibrations and motion of the lure relative to the fishing line will flex and bow the transducer, which will thereby produce an electrical signal.

The electrical signal is coupled with the driver circuitry 4 which receives the electrical signal and uses it to produce a driving signal which, in turn, is supplied to one or more transmitting transducers. The configuration of the driver circuitry may vary depending on the application and is well known to one skilled in the art. For example, circuits similar to those employed in common beepers or small toys may be used.

Generally, the driver circuitry 4 comprises an energy storage circuit and a pulse generator (not shown). Accumulating power from the electrical signals is generally required given their relatively low power. Hence, the energy storage circuit typically comprises a capacitor or similar accumulator to accumulate the electrical signals produced by the energy-harvesting transducer. Once the needed voltage has been accumulated (e.g., the capacitor charged), the energy is passed through a pulse generator to generate a pulsed signal. The pulsed signal is then transmitted to an inductor which generates an electrical field. As is well known, the electric field causes the PFC's to deform at a particular frequency. Naturally, if the power from the electrical signals is accumulated before being used to drive the transmitting transducer, the transmitting transducer will only be driven intermittently. This operation, however, is sufficient and even preferable since natural sounds tend to be irregular.

Rather than using an energy storage circuit to accumulate power, the electrical signal may be powerful enough to drive the transmitting transducer(s) directly or with nominal manipulation. In such a configuration the driver circuitry would comprise a simple electrical interface between the energy-harvesting transducer and the transmitting transducer(s).

As with the energy-harvesting transducer, the transmitting transducers preferably comprise PFCs. Again, such PFCs are described in pending U.S. application Ser. No. 09/834,305, incorporated herein by reference, and are commercially available from Advanced Cerametrics, Lambertville, N.J. In a preferred embodiment, the lure of the present invention has either a plurality of transmitting transducers for transmitting different frequency sonar signals, or a transducer having different fiber sizes for transmitting multiple frequencies.

The transmitting transducers preferably are mounted at or near the surface of the housing to minimize interference and to couple the transducer directly with the medium through which the sonar signals will be propagating, i.e., water. Placement of the PFC sonar elements is the subject of study, but is expected to occur in the ear region of the,lure and/or along the location of the lateral line. It may be necessary to place two different sonar elements to accommodate different frequencies. For example, referring to FIG. 1, a preferred embodiment of transmitting transducers 5a-5c is shown. Transmitting transducer 5a is a lateral line flexible, transducer with a preferred frequency range of about 1 to about 3000 Hz. As shown, transmitting transducer 5a runs along the length of the lure. Its size allows it to be configurable with respect to the frequencies it can transmit; that is, there is ample room for a multiplicity of different fiber types to be used in a signal transducer. Its size also results in a sonar signal of relatively high magnitude. Transmitting transducer 5b is a low frequency transducer with a preferred frequency of less than about 50 Hz. This transducer is located in the ear region of the lure. Like transmitting transducer 5b, transmitting transducers 5c are also located in the ear region of the lure, however, transmitting transducers 5c are high frequency transducers having a preferred frequency range of about 700 to about 3000 Hz. It should be understood that the transducer configuration of FIG. 1 is considered herein for illustrative purposes and that other transducer configurations are well within the scope of the present invention.

What is claimed is:

1. A lure for attracting sea life, said lure comprising:
a housing;
an energy-harvesting transducer contained within said housing and operatively connectable to an external deformation source for deforming said energy-harvesting transducer, said energy-harvesting transducer being configured to generate an electrical signal in response to being deformed;
transducer-driving circuitry contained within said housing and electrically connected to said energy-harvesting device, said transducer-driving circuitry configured to receive said electrical signal and to output a driving signal suitable for powering at least one transmitting transducer; and
at least one transmitting transducer electrically connected to said transducer-driving circuitry, said transmitting transducer deforming in response to said driving signal to generate a sonar signal.

2. The lure of claim 1, wherein said energy-harvesting transducer and said transmitting transducers are piezo-fiber composites.

3. The lure of claim 2, wherein said transmitting transducer is located at the surface of said housing.

4. The lure of claim 2, further comprising:
a plurality of transmitting transducers, wherein at least two transmitting transducer transmit different frequency sonar signals.

5. The lure of claim 2, where said transmitting transducer is capable of deforming at different frequencies to produce sonar signals of different frequency.

6. The lure of claim 1, wherein said external deformation source moves in relation to said lure as a function of wave/current action.

7. The lure of claim 6, wherein said external deformation source is a fishing line.

8. The lure of claim 6, wherein said external deformation source is connected to a buoy.

9. The lure of claim 1, further comprising a connector connected to said energy-harvesting transducer and protruding from said housing to facilitate connection of said external deformation source thereto.

10. The lure of claim 1, wherein said housing is shaped as a fish.

11. The lure of claim 1, wherein said housing is shaped as a shell fish.

12. The lure of claim 1, wherein said housing is shaped as a plant.

13. The lure of claim 1, wherein said housing is shaped as a bug.

14. The lure of claim 1, wherein said transducer-driving circuitry comprises at least:
energy-storing circuitry contained within said housing and electrically connected to said energy-harvesting transducer, said energy-storing circuitry being configured to accumulate energy generated by said energy-harvesting transducer and for outputting a relatively high power signal.

15. The lure of claim 14,wherein energy storing circuitry comprises a capacitor.

16. The lure of claim 14,wherein said transducer-driving circuitry comprises:
a pulse generator for receiving said relatively high power signal from said energy-storage circuitry and for pulsing said high power signal to produce said driving signal.
